(19) United States
(12) Patent Application Publication
(10) Pub. No.: US 2008/0221007 A1
(43) Pub. Date: Sep. 11, 2008

(54) Aqueous Cleaning Compositions

(75) Inventors: Luca Libralesso, Mira VE (IT); Sara Quaggia, Mira VE (IT); Simone Scoizzato, Mira VE (IT); Dora Zamuner, Mira VE (IT)

Correspondence Address: NORRIS, MCLAUGHLIN & MARCUS, 875 THIRD AVE, 18TH FLOOR, NEW YORK, NY, 10022, US

(73) Assignee: Reckitt Benckiser N.V., Hoofddorp (NL)

(21) Appl. No.: 11/914,362

(22) PCT Filed: May 10, 2006
(86) PCT No.: PCT/GB06/01697

§ 371 Date: Dec. 10, 2007

(30) Foreign Application Priority Data
May 16, 2005 (GB) 0509810.8

(51) Int. Cl. C11D 7/18

(52) U.S. Cl. 510/284

(57) ABSTRACT

An aqueous cleaning composition comprising:
hydrogen peroxide or a source thereof;
an anionic sulfonate surfactant;
a fatty acid amide;
a non-ionic surfactant; and
a sarcosinate compound.

This is an application filed under 35 USC 371 of PCT/GB2006/001697.

The present invention relates to an aqueous cleaning composition and to the use of such a composition in cleaning fabric.

It has been found that when certain components are used together in such a composition, the composition being either a stain pre-treater or an in-wash laundry detergent, unexpectedly good cleaning performance is obtained.

According to a first aspect of the present invention, there is provided an aqueous cleaning composition comprising:
hydrogen peroxide or a source thereof;
an anionic sulfonate surfactant;
a fatty acid amide;
a non-ionic surfactant; and
a sarcosinate compound.

A hydrogen peroxide source refers to any water-soluble source of hydrogen peroxide. Suitable water-soluble sources of hydrogen peroxide for use herein include percarbonates, organic or inorganic peroxides and perborates.

Preferably however, the composition comprises hydrogen peroxide. Hydrogen peroxide is commercially available in different grades, at 8%, 35% and 50% w/v active, and it is generally stabilised by the use of chelating agents.

Preferred levels of hydrogen peroxide in the total composition are 0.1-12 wt %, preferably 0.5-8 wt %, more preferably 1-5 wt % and most preferably 2-4 wt %. When a source of hydrogen peroxide is employed it is preferably present in an amount so as to yield the hydrogen peroxide values stated above.

Unless otherwise stated herein, % or % wt values denote weight of a component expressed as a percentage of total composition weight.

Suitable anionic sulfonate surfactants include alkyl benzene sulfonates, alkylsulfonates, alkylamide sulfonates, alkylarylsulfonates, olefinsulfonates and paraffin sulfonates.

When a percentage figure is given for a component, it denotes the total complement of that component, which may be supplied by more than one compound of that type.

Preferably the composition of the present invention comprises at least 1 wt % anionic sulfonate surfactant, more preferably at least 3 wt % and most preferably at least 4 wt %.

Preferably the composition comprises up to 20 wt % anionic sulfonate surfactant, more preferably up to 15 wt % and most preferably up to 10 wt %.

Preferably the composition comprises an alkylaryl sulfonate. Especially preferred is a linear alkylbenzene sulfonate (most preferably a sodium salt thereof).

Preferably the composition further comprises an anionic sulfate surfactant, preferably an anionic alkyl sulfate surfactant of the formula (I):

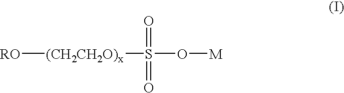

wherein R is a straight chain or branched alkyl chain having from about 8 to about 18 carbon atoms, saturated or unsaturated, and the longest linear portion of the alkyl chain is no more than 15 carbon atoms, M is a cation, especially of an alkali metal such as sodium, and x is from 0 to 4. Preferably x is 2 and the sulfate is C12-15 primary or secondary alkyl sulfate, most preferably sodium laurylethersulfate (2EO).

Preferably the composition of the present invention comprises at least 0.1 wt % anionic sulfate surfactant, more preferably at least 0.5 wt % and most preferably at least 1 wt %.

Preferably the composition comprises up to 20 wt % anionic sulfate surfactant, more preferably up to 15 wt % and most preferably up to 10 wt %.

The fatty acid amide of the composition of the present invention is preferably formed by reaction of a secondary amine with a long chain fatty acid. The fatty acid amide is distinct from the sarcosinate component, and preferably comprises only one carbonyl group. Suitable fatty acids are those derived from a natural oil, preferably a natural oil comprising fatty acids having 10 to 20 carbon atoms, more preferably 12 to 16 carbon atoms. It is to be understood that as such the amide component may in fact comprise a mixture of amides, as result of it having been synthesized from a natural oil comprising a mixture of acids. Especially preferred amides for use in the present invention are those formed by the reaction of coconut oil with a secondary amine.

The secondary amine may be, for example, an alkyl or aryl amine. Preferably it is a dialkanolamine, especially one in which the alkanol groups comprise 1 to 4 carbons atoms. Preferably the alkanol groups are the same, preferably they are both ethanol. Thus an especially preferred amine is diethanolamine and an especially preferred fatty acid amide is coconut diethanolamide.

Preferably the composition of the present invention comprises at least 0.1 wt % fatty acid amide, more preferably at least 0.5 wt %, more preferably at least 1 wt % and most preferably at least 2 wt %.

Preferably the composition comprises up to 10 wt % fatty acid amide, more preferably up to 8 wt %, more preferably up to 5 wt %, and most preferably up to 4 wt %.

Preferably the anionic sulfonate surfactant is present in weight excess compared to the fatty acid amide.

The nonionic surfactant is preferably a polyalkoxylated alcohol. It may suitably be present in an amount of 6-15 wt %.

In particular, there may be more than one polyalkoxylated alcohol. Suitable polyalkoxylated alcohols are comprised of C10-C18 alcohol residues joined by 1 to 10 ethoxy or propoxy moieties. Preferred polyalkoxylated alcohols are polyethoxylated C12-C16 alcohols. In preferred embodiments, the composition comprises a C12-C16 alcohol having 7 ethoxy groups (oxo alcohol C12-C16 7EO, in amount of 5-10 wt %) and a C12-C16 alcohol having 3 ethoxy groups (oxo alcohol C12-C16 3EO, in an amount of 1-5 wt %).

The sarcosinate compound is preferably present in an amount of up to 10 wt %, more preferably up to 6 wt % and most preferably up to 4 wt %.

Preferred sarcosinate compounds are formed by the reaction of sarcosine (N-methylglycine) with a long chain carboxylic acid, preferably one having 10 to 16 carbon atoms. Most preferably the composition comprises sodium lauryl sarcosinate.

The compositions of the present invention may comprise a chelating agent or a mixture thereof as a preferred optional ingredient. Suitable chelating agents may be any of those known to those skilled in the art such as the ones selected from the group comprising phosphonate chelating agents, amino carboxylate chelating agents, other carboxylate chelating agents, polyfunctionally-substituted aromatic chelating agents, ethylenediamine N,N′-disuccinic acids, or mixtures thereof. The chelating agents inactivate the metal ions present on the surface of the fabrics and/or in the cleaning compositions (neat or diluted) that otherwise would contribute to the radical decomposition of any peroxygen bleach.

Suitable phosphonate chelating agents to be used herein may include alkali metal ethane 1-hydroxy diphosphonates (HEDP) also known as ethydronic acid, alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP or ethydronic acid). Such phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins.

Suitable amino carboxylates to be used herein include ethylene diamine tetra acetates, diethylene triamine pentaacetates, diethylene triamine pentaacetate (DTPA), N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-acetic acid (MGDA).

Further carboxylate chelating agents to be used herein include salicylic acid, aspartic acid, glutamic acid, glycine, malonic acid or mixtures thereof.

Particularly preferred chelating agents to be used herein are amino aminotri(methylene phosphonic acid), di-ethylene-triamino-pentaacetic acid, diethylene triamine penta methylene phosphonate, 1-hydroxy ethane diphosphonate, ethylenediamine N,N′-disuccinic acid, and mixtures thereof.

Typically, the compositions according to the present invention comprise up to 5% wt of the total composition of a chelating agent, or mixtures thereof, preferably from 0.005 to 2% wt, more preferably from 0.01 to 1% wt and most preferably from 0.1 to 0.5% wt.

Optionally the composition of the present invention further comprises a fragrance.

Preferably the composition of the present invention is substantially free of phosphono surfactants. By substantially free, we mean that the composition comprises less than 2 wt % phosphono surfactant, preferably less than 1 wt %, more preferably less than 0.5 wt % and most preferably less than 0.1 wt %. Most preferably the composition is entirely free from phosphono surfactants.

According to a second aspect of the present invention there is provided an aqueous cleaning composition, substantially free of any phosphono surfactant and comprising:
0.1-12 wt % hydrogen peroxide (preferably 0.5-8 wt %, more preferably 1-5 wt %);
1-20 wt % linear benzenealkylsulfonate (preferably 2-15 wt %, more preferably 4-10 wt %); and
0.1-10 wt % coconut diethanolamide (preferably 1-8 wt %, more preferably 2-5 wt %).

Preferred features of the second aspect are as defined in relation to the first aspect.

It has been found, surprisingly, that the combination of a linear benzenealkylsulfonate and coconut diethanolamide has a synergistic effect on cleaning a fabric, using a peroxide cleaning composition, particularly in relation to the removal of greasy stains.

According to a third aspect of the present invention there is provided a method of cleaning a fabric using a composition of the first or second aspect.

Preferably the method of the present invention comprises a first step of locally applying the composition of the first or second aspect to an area of fabric to be treated. In an especially preferred method, the composition is applied an area of fabric soiled by a greasy stain.

The method may comprise a second step of simply rinsing the fabric to remove the composition. Alternatively, a second step may comprise washing the fabric in a laundry washing machine.

Alternatively, the method could comprise adding the composition to a laundry washing machine so that it acts as a “booster” during the wash process i.e. it comprises an extra cleaning effect in addition to that provided by the normal detergent which is also used.

The invention will now be further described with reference to the following non-limiting examples which illustrate the surprising synergistic cleaning effect of a combination of a linear benzenealkylsulfonate and coconut diethanolamide.

### EXAMPLES 1-8

A factorial design of experiment method was used to select various combinations of compositions so that the relative effects of having high or low concentrations of the following could be examined: sodium alkylbenzenesulfonate (LAS); sodium laurylethersulfate (2EO); coconut diethanolamide and sodium lauryl sarcosinate.

The following formulations were prepared:

| | Formula: | | | | | | | |
|---|---|---|---|---|---|---|---|---|
| | 1 | 2 | 3 | 4 | 5 | 6 | 7 | 8 |
| | Wt % | Wt % | Wt % | Wt % | Wt % | Wt % | Wt % | Wt % |
| Hydrogen | 3.00 | 3.00 | 3.00 | 3.00 | 3.00 | 3.00 | 3.00 | 3.00 |
| peroxide | | | | | | | | |
| Chelating agent | 0.12 | 0.12 | 0.12 | 0.12 | 0.12 | 0.12 | 0.12 | 0.12 |
| (HEDP) | | | | | | | | |
| Sodium | | 8.00 | | 8.00 | | 8.00 | | 8.00 |
| alkylbenzene | | | | | | | | |
| sulfonate (LAS) | | | | | | | | |
| Oxo alcohol | 8.00 | 8.00 | 8.00 | 8.00 | 8.00 | 8.00 | 8.00 | 8.00 |
| C12-16 + 7EO | | | | | | | | |
| Oxo alcohol | 2.50 | 2.50 | 2.50 | 2.50 | 2.50 | 2.50 | 2.50 | 2.50 |
| C12-16 + 3EO | | | | | | | | |
| Sodium | 2.00 | 8.00 | 8.00 | 2.00 | 8.00 | 2.00 | 2.00 | 8.00 |
| laurylether | | | | | | | | |
| sulfate (2EO) | | | | | | | | |
| Sodium lauryl | | | 3.00 | 3.00 | | | 3.00 | 3.00 |
| sarcosinate | | | | | | | | |
| Coconut | | | | | 3.00 | 3.00 | 3.00 | 3.00 |
| diethanolamide | | | | | | | | |
| Fragrance | 0.17 | 0.17 | 0.17 | 0.17 | 0.17 | 0.17 | 0.17 | 0.17 |
| Deionised water | 84.21 | 70.21 | 75.21 | 73.21 | 75.21 | 73.21 | 78.21 | 64.21 |
| Total | 100 | 100 | 100 | 100 | 100 | 100 | 100 | 100 |

The pH of these compositions is 5-6. They are flowable but rather viscous liquids (viscosity at 20° C. is 900-1500 cps under standard measurement conditions).

The performance each of these formulations was evaluated using the following method:

Removal of a greasy stain selected from mayonnaise/chlorophyll, make-up, lipstick and dirty motor oil was attempted. These stains were standardised stains purchased from commercial sources.

Each formulation tested was an 80 ml sample. 2 ml of the formulation was applied to the stain and left to react for 5 minutes. The area was rubbed manually backwards and forwards 5 times and the remainder of the 80 ml of formulation was added in addition to liquid detergent in a Maytag performa washing machine. The liquid detergent was Purex liquid from Dolly. The fabric (2 kg of white cotton ballast) was washed on a deep cleaning program (30° C. for 90 minutes, using 55 litres of water in the main wash, water hardness 25° F.).

A block of 4 washing machines was used and each formulation went into 2 different machines. Each formulation was tested twice to give 2 internal and 2 external replicates for each formulation.

The stain removal performance was evaluated by measuring the stain before and after treatment using an Ultrascan XE Spectrophotometer, from HunterLab.

The following results were obtained:

Y-value average for greasy stains

| | Formula: | | | | | | | |
|---|---|---|---|---|---|---|---|---|
| | 1 | 2 | 3 | 4 | 5 | 6 | 7 | 8 |
| Replication 1 | 68.32 | 69.13 | 68.05 | 69.25 | 68.92 | 70.39 | 67.88 | 69.90 |
| Replication 1 | 68.16 | 69.25 | 68.53 | 68.55 | 68.95 | 70.15 | 68.41 | 69.64 |
| Replication 2 | 67.96 | 68.85 | 67.01 | 68.97 | 67.79 | 69.56 | 68.47 | 69.90 |
| Replication 2 | 67.69 | 68.76 | 67.19 | 68.64 | 67.12 | 69.56 | 67.93 | 69.77 |

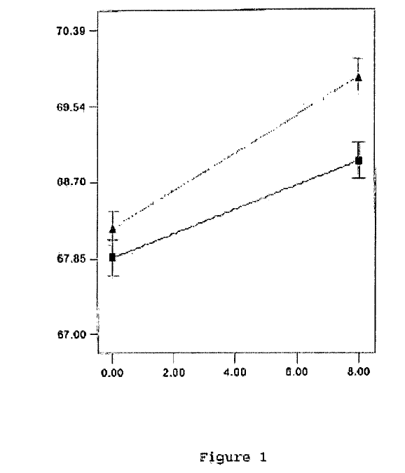

The results showed that performance improved non-additively when a combination of alkyl benzene sulfonic acid and coconut diethanolamide was used. This is best illustrated by considering the graph shown in FIG. 1. The graph was plotted by taking an average of the values recorded (those shown in the table above). Once all the response values were obtained, stastical analysis was undertaken by analysis of variants (ANOVA).

FIG. 1 is an interpolation, assuming a notational level of sarcosinate and sodium laurylether sulphate (2EO) of 1.5 wt % respectively. The x-axis shows the percentage of sodium alkylbenzene sulfonate in the composition and the y-axis shows the average reflectance reading. The bottom line represents the cleaning performance when there is no coconut diethanolamine present, and the top line represents the cleaning.

Ordinarily, it would be anticipated that the two lines would be parallel, i.e. that the presence of coconut diethanolamide would lead to an increase in cleaning performance, but that this improval would be independent of the concentration of alkyl benzene sulfonic acid present in the composition.

The fact that the two lines are of differing gradients is an indication of the synergistic cleaning effect of using such a combination. Statistical analysis showed the increase in activity at 3 wt % to be significant; the error bars are shown on the graph.

### EXAMPLE 9

Using information derived from the tests described above the following formula may be derived.

| | | |
|---|---|---|
| Hydrogen peroxide | 3.0 | wt % |
| Chelating agent HEDP | 0.12 | wt % |
| Sodium alkylbenzene sulfonate | 5.0 | wt % |
| Oxo alcohol C12-16 + 7EO | 7.8 | wt % |
| Oxo alcohol C12-16 + 3EO | 2.2 | wt % |
| Sodium laurylethersulfate (2EO) | 2.2 | wt % |
| Sodium lauryl sarcosinate | 1.0 | wt % |
| Coconut diethanolamine | 2.8 | wt % |
| Perfume | 0.17 | wt % |

| | |
|---|---|
| Water | balance |

1. An aqueous cleaning composition comprising:
hydrogen peroxide or a source thereof;
an anionic sulfonate surfactant;
a fatty acid amide;
a non-ionic surfactant; and
a sarcosinate compound.

2. A composition according to claim 1 wherein the anionic surfactant comprises an alkylarylsulfonate.

3. A composition according to claim 1 or 2 wherein the anionic surfactant comprises a linear alkyl benzene sulfonate.

4. A composition according to any preceding claim wherein the fatty acid amide is formed by reaction of a secondary amine with a natural oil.

5. A composition according to any preceding claim wherein the fatty acid amide is coconut diethanolamide.

6. A composition according to any preceding claim wherein the nonionic surfactant comprises a polyalkoxylated alcohol.

7. A composition according to any preceding claim wherein the sarcosinate compound is sodium lauryl sarcosinate.

8. A composition according to any preceding claim which further comprises an anionic sulfate surfactant.

9. A composition according to any preceding claim wherein the composition is substantially free of any phosphono surfactant.

10. An aqueous cleaning composition, substantially free of any phosphono surfactant and comprising:
0.1-12 wt % hydrogen peroxide;
1-20 wt % linear benzenealkylsulfonate; and
0.1-10 wt % coconut diethanolamide.

11. A method of cleaning a fabric using a composition as claimed in any preceding claim.

12. A method as claimed in claim 11 wherein the method comprises locally applying the composition to an area of fabric to be treated and then rinsing the fabric.

13. A method as claimed in claim 11 wherein the method comprises applying a portion of the composition locally to an area of fabric to be treated, placing the fabric in a washing machine, adding further such composition with a detergent to the washing machine, and then running a machine wash program.

14. Use of a composition as claimed in any of claims 1-10 in the cleaning of greasy stains on fabric.
